(19) United States
(12) Patent Application Publication
(10) Pub. No.: US 2024/0104565 A1
(43) Pub. Date: Mar. 28, 2024

(54) SYSTEM AND METHOD FOR PROCESSING FINANCIAL TRANSACTION HAVING A BOUND MERCHANT

(71) Applicant: Capital One Services, LLC, McLean, VA (US)

(72) Inventors: Pavel FORT, Westbury, NY (US); Lawrence DOUGLAS, McLean, VA (US); Jeffrey WIEKER, Falls Church, VA (US)

(73) Assignee: Capital One Services, LLC, McLean, VA (US)

(21) Appl. No.: 17/950,429

(22) Filed: Sep. 22, 2022

(51) Int. Cl. G06Q 20/40; G06Q 20/34; G06Q 20/42

(52) U.S. Cl. CPC G06Q 20/4014; G06Q 20/351; G06Q 20/42

(57) ABSTRACT

A system and method for processing a bound payment method is disclosed. A customer can create a virtual card number for use solely at a specific retailer. In this scenario, when the payment method is used for a financial transaction, it becomes necessary to verify that the financial transaction is being carried out with the bound merchant. In embodiments, the virtual card number (VCN) information is received and analyzed to identify the exchange entity and a bound entity associated with the VCN. If it is determined that the merchant associated with the transaction does not match the bound merchant associated with the VCN, then the customer is notified of the discrepancy and provided an opportunity to confirm the dispute the denial.

### TECHNICAL FIELD

Embodiments of the present disclosure are related to processing of financial transactions, and specifically to processing financial transactions involving payment methods having a bound merchant.

### BACKGROUND

Traditionally, payment for goods and services was limited to cash, check, or credit card. More recently, however, a wide variety of payment methods have become available, including crypto, virtual card number, etc. For several of these different payment methods, customers are able to bind the payment method to a particular merchant. For example, the customer can create a virtual card number for use solely at a specific retailer. In this scenario, when the payment method is used for a financial transaction, it may be difficult to verify whether the financial transaction is being carried out with the bound merchant.

### BRIEF DESCRIPTION OF THE DRAWINGS/FIGURES

The accompanying drawings are incorporated herein and form a part of the specification.

FIG. 1 illustrates an exemplary transaction processing environment according to embodiments.

FIG. 2 illustrates a block diagram of an exemplary transaction processing system according to various embodiments.

FIG. 3 illustrates an exemplary user interface for use with the transaction processing system according to various embodiments.

FIG. 4 illustrates an exemplary message flow diagram for carrying out the transaction processing according to various embodiments.

FIG. 5 illustrates a flowchart diagram of an exemplary method for processing a bound merchant transaction according to embodiments.

FIG. 6 illustrates an exemplary computer system for implementing some aspects of the disclosure or portion(s) thereof.

In the drawings, reference numbers generally indicate identical or similar elements. Additionally, generally, the left-most digit(s) of a reference number identifies the drawing in which the reference number first appears.

### DETAILED DESCRIPTION

Provided herein are a method, a system, computer program product embodiments, and/or combinations and sub-combinations thereof for processing financial transactions involving payment methods having a bound merchant.

When a customer provides payment information to a merchant in order to pay for goods and/or services, the merchant packages the payment information along with other transaction-related information and forwards this information to the financial institution for review and approval. Upon receipt of the information, the financial institution attempts to parse the payment information in order to identify the customer and the payment account. Sometimes, analysis of the payment information will reveal that the payment account is bound to a particular merchant (i.e., merchant bound). This indicates that the payment method can only be used with that particular merchant.

In this scenario, the financial institution may then attempt to determine from the payment information, whether the transaction is being originated from the bound merchant or from an unauthorized merchant. Generally, within the payment information transmitted to the financial institution from the merchant, there is included certain identifying indicia of the merchant. However, there is no standard formatting for any such indicia, and single merchants are known to have hundreds or even thousands of different formats. In some circumstances, such as the foregoing, a machine-learning model is used in order to attempt to identify the merchant from the often-jumbled payment information.

Once the merchant associated with the payment information is identified, it is compared to the bound merchant on file with the payment account. If a match is identified, then the financial transaction is approved. However, if a mismatch is identified, then the financial transaction is declined.

However, because of the nature of the payment information and/or because a machine-learning model may be inadequately trained to identify the merchant, there are often erroneous approvals as well as erroneous denials that typically result from a misidentification of the merchant from the payment information.

Therefore, according to embodiments of the present disclosure, following a decision to approve or deny a financial transaction based on a bound payment method, the customer is notified of the decision and asked to confirm or dispute the decision. The customer's response serves several purposes, but primarily allows the system to identify an erroneous decision, to correct it, and also to improve future accuracy of similar payment information by using the customer response for retraining of the machine-learning model. Various embodiments of these features will now be discussed with respect to the corresponding figures.

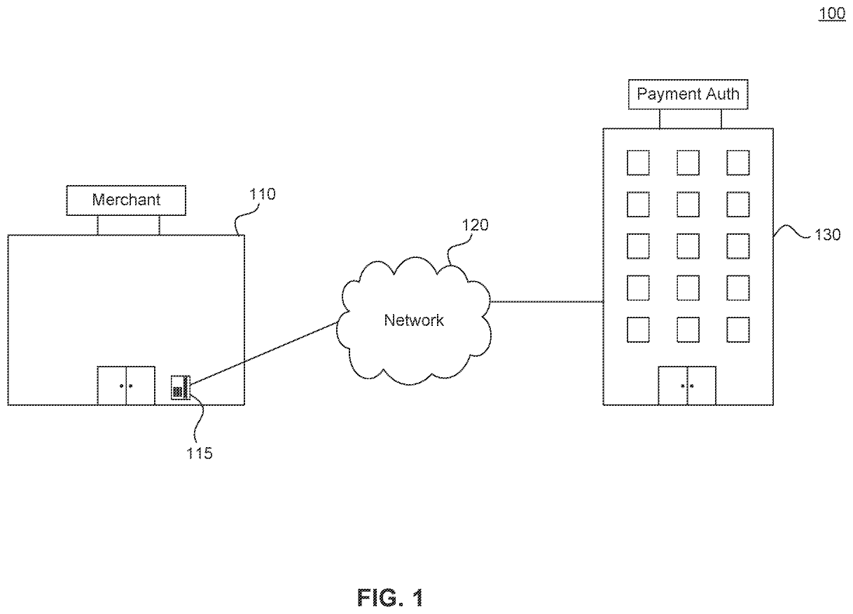

FIG. 1 illustrates an exemplary transaction processing environment 100 according to embodiments. As shown in FIG. 1, a Merchant 110 includes a payment terminal 115. The payment terminal communicates with a Financial Institution 130 via a network 120. In the embodiment of FIG. 1, a customer attempts to make a purchase at the Merchant 110 by providing the customer's payment information to the payment terminal 115. The payment terminal 115 packages the customer's payment information along with certain transaction and merchant information, and forwards this information to the financial institution 130 via the network 120.

Upon receipt, the financial institution 130 performs the necessary analysis of the payment information and approves or declines the transaction. The decision is transmitted back to the payment terminal 115 via the network 120, which then completes the transaction or terminates the transaction depending on the response. At the same time, the financial institution 130 contacts the customer to request confirmation of the approval decision, as will be described in further detail below. It should be noted that the financial transaction need not occur within the merchant—the transaction can also be attempted remotely and/or virtually to the same effect. Similarly, the financial institution 130 need not communicate with a payment terminal, but can instead communicate with any number of payment servers, payment processors, or other payment processing devices associated with the merchant.

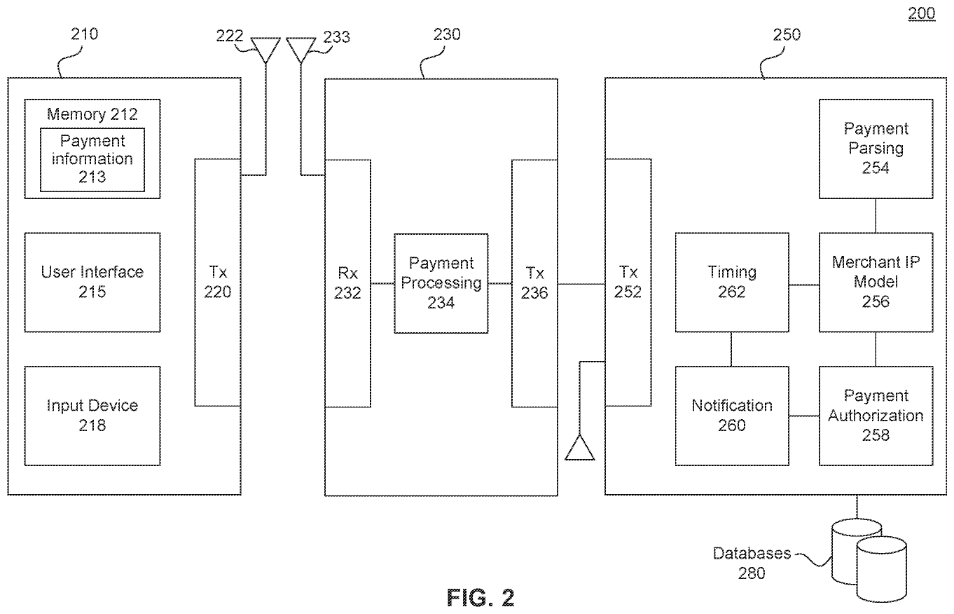

FIG. 2 illustrates a block diagram of an exemplary transaction processing system 200 according to various embodiments. As shown in FIG. 2, a customer device 210, a payment terminal, and a financial institution transaction processing server 250 communicate with each other in order to carry out the financial transaction.

As shown in FIG. 2, the customer device 210 includes a memory 212 that stores the payment information 213, a user interface 215, an input device 218, and a transceiver 220 having one or more antennas 222. In an embodiment, the customer device 210 is a wireless communication device such as a cellular telephone, tablet computer, etc., the user interface is a display screen upon which information is displayed to the customer, and the input device is a keyboard, keypad, or touchscreen. Although the example of FIG. 2 shows the payment information being stored in the memory 212 and provided by the customer device to the payment terminal, the payment information could instead be provided separately, either from a card or entered manually into the merchant system (e.g., such as for an online transaction), or in other ways.

The payment terminal 230 includes a receiver 232 having one or more antennas 233, a transceiver 236, and payment processor 234. The receiver 233 receives the payment information from the customer device 210 via the antenna 233. The payment processor 234 packages the received payment information with additional information, such as transaction amount, merchant information, etc., and transmits the payment information to the transaction processing server 250. Once again, payment need not be received at a physical terminal. Rather, the payment terminal can instead be a payment server associated with a merchant that receives the payment information and processes a transaction, such as an online transaction.

Transaction processing server 250 includes a transceiver 252 for communicating with one or more of the payment terminal 230 and/or the customer device 210. In embodiments, the transceiver 252 may include one or more antennas 253, or may be configured for only wired communications. The transaction processing server 250 further includes one or more processors for carrying out a variety of payment processing functions, including payment parsing 254, merchant ID model 256, payment authorization 258, notification 260, and training 262.

The payment processing server 250 receives the payment information from the payment terminal 230 via the transceiver 252. Payment parsing 254 is responsible for reviewing and analyzing the received payment information in order to separate the received payment information into its component parts, including account number, transaction amount, and merchant information. The payment processing server 250 may be in communication with one or more databases 280 that store account, customer and/or merchant data. The payment processing server 250 accesses the databases 280, and determines whether the account being used for the financial transaction is a merchant-bound account.

Any information that is deemed to be useful for identifying the merchant is then provided to the merchant ID model 256. In embodiments, the model is a machine-learning algorithm for identifying the merchant from the payment information received from the merchant. After the merchant has been identified, it is compared to the merchant to which the account is bound. Based on this comparison, payment authorization 258 either authorizes or declines the transaction.

In one embodiment, the system 200 can generate the merchant decision using one or more of a variety of machine learning models and processes including, Support Vector Machine, Naïve Bayes, Convolutional Neural Networks models, in addition to classification models, such as Bag of Words, Logistic Regression, or Doc2Vec models. In one embodiment, the model 256 can generate merchant identification decisions based on searching for and finding a keyword 446 in the text, image, or a combination thereof of the merchant ID information.

In embodiments, the model 256 can generate the merchant ID decision through a variety of methods and techniques. For example, the merchant determination can be generated through knowledge-based techniques, statistical methods, or hybrid methods. Knowledge-based techniques refers to lexicon-based techniques that utilize domain knowledge and the semantic and syntactic characteristics of language in order to detect certain emotion types. Examples of knowledge-based techniques include classification of a keyword based on classification models such as WordNet, SenticNet, ConceptNet, EmotiNet, and Bag of Words as examples. Statistical methods refers to methods in which a large set of annotated data is processed such that the model 256 learns and predicts the appropriate merchant based on available evidence. Examples of statistical methods include Support Vector Machines, Naïve Bayes, Maximum Entropy, Convolutional Neural Networks, Long Short-term Memory, and Extreme Learning Machine models as examples. Hybrid methods refers to a combination of knowledge-based techniques and statistical methods.

Notification 260 transmits a notification to the user of the payment authorization decision, and requests confirmation of its accuracy. The notification 260 receives a response message from the user, and provides the response information to training 262. Training 262 uses the response information about the accuracy of the decision to retrain the merchant ID model 256.

In operation, the customer seeking to complete a financial transaction brings their device within the vicinity of payment terminal 230, inserts or swipes a payment card at the payment terminal, or enters payment information online. In the example of FIG. 2, the payment information is provided by bringing the device within the vicinity of the payment terminal and wireless transmitting the payment information 213 from the memory 212 to the payment terminal 230 via the transceiver 220, receiver 232 and their respective antennas 222 and 233. Payment terminal receives the payment information and payment processing 234 packages the payment information along with the additional information relating to the transaction, such as payment amount, merchant information, etc. The payment terminal transmits the payment information package to the payment processing server 250 via transmitter 236.

The payment processing server 250 receives the payment information package at its transceiver 252. Payment parsing 254 parses the payment package into as many components as it can, including account number, payment amount, etc. However, as discussed above, there is no standard format by which merchants transmit this information. Therefore, the merchant information is not always easily parseable. Using the extracted account number, the payment authorization 258 accesses the databases 280 in order to determine whether the account is merchant-bound. If it is, then the merchant information is provided to the merchant ID model 256.

The merchant ID model 256 uses its machine-learning model on the merchant information in order to attempt to identify the merchant with which the transaction is sought. Once the merchant is identified, the payment authorization 258 compares the identified merchant to the bound merchant. If they match, then the transaction is authorized. However, if they do not match, then the transaction is declined. This authorization decision is transmitted from the payment processing server 250 to the payment terminal 230 via the transceivers 252 and 236. The payment terminal receives the authorization decision and either completes or terminates the transaction based on the decision.

Meanwhile, the notification 260 of the payment processing server 250 transmits a notification to the customer device 210, informing the customer of the authorization decision and requesting confirmation that the decision was accurate. In embodiments, the notification may be a text message, an email, or a telephone call (live or automated), among others. In an example of a text message notification, the notification is received via the antenna 222 and transceiver 220 of the customer device 210 and displayed on the user interface 215. In an embodiment, the notification message both informs the customer of the authorization decision and requests confirmation of the decision. For example, such a notification may state for a declined transaction: “Your payment was declined because it did not match the bound merchant on file for this account. Was this correct? (Y/N)”. The customer provides a response using input device 218, which is then transmitted back to the payment processing server via transceiver 220 and antenna 222.

Notification 260 receives the response from the customer via transceiver 252, and provides the response information to training 262. For example, in the event that the customer refutes the authorization decision, the information is provided to the training 262 along with the correct merchant identification. In other words, the bound merchant identifier is provided as the correct merchant identifier along with the merchant information from the payment information package. These data items provide a new data point to the machine-learning model for training the model. Thereafter, the notification 260 transmits a reply notification to the customer device telling the customer to re-attempt the transaction.

Although the above discloses one exemplary embodiment for carrying out the transaction processing, there may be several variants within the scope of this disclosure. For example, in an embodiment, notifications to the customer may occur only after declining a particular transaction. In another embodiment, proactive notifications are not sent at all, and instead action is only taken to retrain the model in response a customer contacting the financial institution to dispute the authorization decision.

In yet another embodiment, the model is not retrained as an immediate response to customer feedback, but rather only after enough similar responses have been received from other customers. In other words, when the customer replies to the notification, the response information (e.g., the allegedly erroneous decline, the merchant information from the payment information package, and the bound merchant) are stored, for example in the databases 280. Similar responses relating to the same or similar merchant information are also stored until those responses reach some predetermined threshold. In embodiments, the threshold may have a time component such that the predetermined threshold must be reached within a given time, and old responses are dropped. Nonetheless, once a sufficient number of replies have been received, then the information is used to retrain the model.

In still another embodiment, the feedback step can be avoided altogether. In this embodiment, errors can be detected on their own over time. Specifically, because the merchant identification model 256 is a machine-learning model, the algorithm for analyzing the merchant information is always evolving and changing. Therefore, in this embodiment, authorization decisions are logged for future review. Each time the model 256 is updated, those earlier transactions are reviewed for errors. In an embodiment, this review can be performed by running those transactions through the updated model. When an error is detected, the customer can be notified of the error, and told to reattempt the transaction. In the manners described above, processing of a merchant-bound transaction can be effectuated.

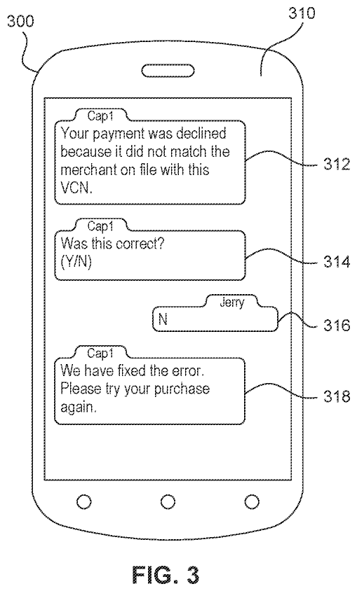

FIG. 3 illustrates an exemplary user interface 300 for use with the transaction processing system according to various embodiments. As shown in FIG. 3, the user interface is displayed to the customer within a display screen 310 of the customer device. In the embodiment of FIG. 3, the customer device receives and displays the notification message from financial institution. In the example of FIG. 3, the notification message 312 states “Your payment was declined because it did not match the merchant on file with this VCN.” In this example, the notification message includes a follow up message 314 that asks for confirmation of the authorization decision: “Was this correct? (Y/N)”. In response to those messages, the user may enter and send a response to the financial institution. In the embodiment of FIG. 3, the customer replies “N,” meaning that the authorization decision was erroneous. Thereafter, the customer device receives and displays the reply message 318 received from the financial institution. As the example of FIG. 3, the reply message states “We have fixed the error. Please try your purchase again.”

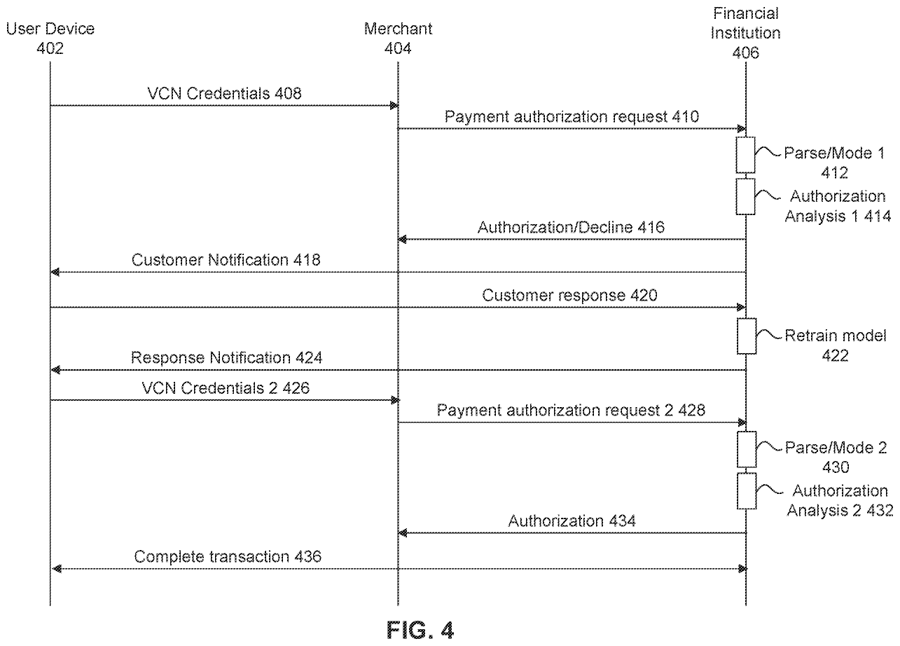

FIG. 4 illustrates an exemplary process flow diagram for carrying out the transaction processing according to various embodiments. As shown in FIG. 4, messages and other information are exchanged between the user device 402, the merchant 404 and the transaction processing server associated with the financial institution 406.

As shown in FIG. 4, the process begins by the user device 402 transmitting VCN or other payment credentials 408 to the merchant 404. The merchant 404 compiles the payment information along with other transaction information into a payment information package and transmits the payment information package to the financial institution 406 as a payment authorization request 410.

At the financial institution 406, the information is parsed, and the merchant information is provided to the model 412. Based on the results of the model and the payment information, an authorization decision is determined that either approves or declines the transaction. This authorization/declination 416 is then transmitted to the merchant to allow for completion or termination of the transaction. Specifically, if the transaction is approved, then the transaction can be completed, and if the transaction is declined, then the merchant cancels the transaction.

At or around the same time, the financial institution 406 also transmits a customer notification 418 to the user device 402. In an embodiment, the customer notification 418 informs the user of the authorization decision, provides a reason for the decision, and asks for confirmation that the decision was correct. The user enters a response into their device, and a customer response 420 is transmitted back to the financial institution 406.

If the customer response indicates that the authorization decision was erroneous, then the information is used to retrain the model 422. Once retrained, a reply notification 424 is transmitted back to the user device requesting that the user reattempt the transaction. In response, the customer again provides the payment credentials 426 to the merchant 404. The merchant 404 packages the payment information with merchant and transaction information, and transmits a second payment authorization request 428 to the financial institution 406. The financial institution 406 again parses and models the information in order to identify the merchant and the bound merchant. Based on the analysis 430, the financial institution 406 makes a second authorization determination 432 to approve the previously declined transaction. The financial institution 406 then transmits authorization to the merchant 404 for completing the transaction 436.

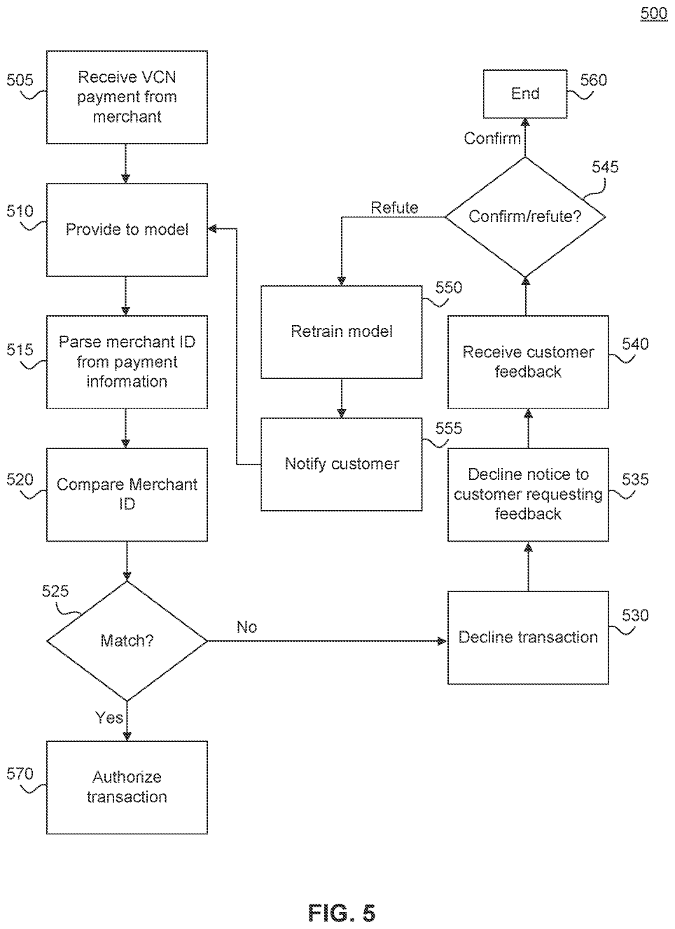

FIG. 5 illustrates a flowchart diagram of an exemplary method 500 for processing a bound merchant transaction according to embodiments. As shown in FIG. 5, the method begins with the receiving of a payment information package from the merchant 505. According to embodiments, the payment information package includes payment information associated with the customer's form of payment, transaction information such as transaction amount, and merchant information such as merchant identification information. The merchant information is provided to the model at step 510 in order to identify the merchant at which the transaction is taking place. Based on the results of the model, the merchant identification is identified from the payment information package at step 515.

Once the merchant identification is determined, it is compared against the bound merchant associated with the payment account in step 520. A determination is then made as to whether the transaction merchant (identified from the model) matches the bound merchant in step 525. If the merchants match (525—Yes), then the transaction is authorized in step 570 and the method concludes. If, however, the merchants do not match (525—No), then the transaction is declined in step 530.

After declining the transaction, the payment processing server transmits a decline notification 535 to the customer. In an embodiment, the decline notification informs the customer that the transaction was declined and requests confirmation of the decision. Customer feedback is received in step 540 that confirms or refutes the authorization determination. If confirmed (545—Confirm), the method ends in step 560. However, if the customer refutes the authorization decision (545—Refute), then the model is retrained in step 550 using the information received from the customer and previously-received payment information package including the merchant information. Once retrained, the customer is notified in step 555 to retry the transaction, and the method returns to step 510. In an embodiment, rather than repeating the entire method following the customer notification at step 555, the transaction is automatically approved upon receipt of the attempted retry.

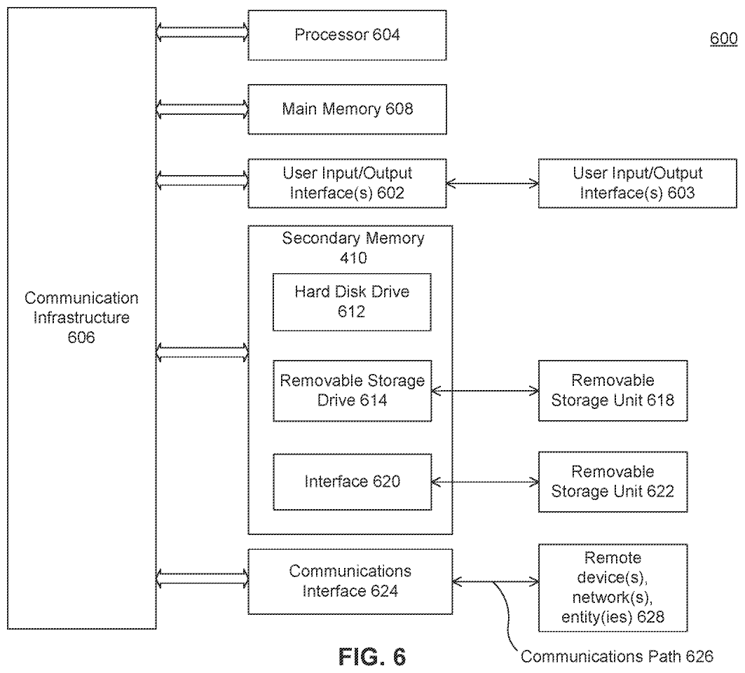

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for processing a virtual card number (VCN) exchange, comprising:
receiving VCN information relating to an attempted exchange that includes identification of an exchange entity;
analyzing the VCN information in order to identify the exchange entity and a bound entity associated with the VCN;
denying the attempted exchange based on the analyzing;
transmitting a notification message to a customer associated with the VCN requesting confirmation of the denying;
receiving a response message from the customer in response to the notification message that confirms or refutes the denying; and
re-analyzing the VCN information based on the response message.

2. The method of claim 1, wherein the analyzing includes providing the VCN information to a machine-learning model configured to parse out the identification of the exchange entity.

3. The method of claim 2, wherein the bound entity is an entity to which use of the VCN is limited.

4. The method of claim 3, further comprising comparing the exchange entity to the bound entity.

5. The method of claim 3, wherein the transmitting of the notification message is performed in response to determining that the exchange entity does not match the bound entity.

6. The method of claim 5, further comprising:
in response to the response message disputing the denying of the attempted exchange, re-training the machine-learning model with the VCN information and an indication that the exchange entity should match the bound entity.

7. The method of claim 6, further comprising:
transmitting a reply message to the customer requesting them to retry the attempted exchange.

8. A exchange server for processing a virtual card number (VCN) exchange, comprising:
a memory that stores customer and entity data;
a transceiver; and
one or more processors configured to:
receive VCN information relating to an attempted exchange, the VCN information including identification of an exchange entity;
analyze the VCN information in order to identify the exchange entity and a bound entity associated with the VCN;
deny the attempted exchange based on the analyzing;
transmit, via the transceiver, a notification message to a customer associated with the VCN requesting confirmation of the denial;
receiving a response message from the customer in response to the notification message that confirms or refutes the denying; and
re-analyzing the VCN information based on the response message.

9. The exchange server of claim 8, wherein the analyzing includes providing the VCN information to a machine-learning model configured to parse out the identification of the exchange entity.

10. The exchange server of claim 9, wherein the bound entity is an entity to which use of the VCN is limited.

11. The exchange server of claim 9, wherein the one or more processors are further configured to compare the exchange entity to the bound entity.

12. The exchange server of claim 11, wherein the one or more processors are further configured to:
determine that the exchange entity does not match the bound entity; and
transmit the notification message in response to the determining.

13. The exchange server of claim 12, wherein the one or more processors are further configured to:
in response to the response message, re-train the machine-learning model with the VCN information and an indication that the exchange entity should match the bound entity.

14. The exchange server of claim 13, wherein the one or more processors are further configured to transmit a reply message to the customer, via the transceiver, requesting that the customer retry the attempted exchange.

15. A method for processing an exchange, comprising:
receiving information associated with the exchange;
identifying an exchange entity and a customer identification within the information;
identifying, based on an analysis of the information, a bound entity associated with the information;
generate an approval decision that either approves or denies the exchange based on the identified bound entity and the exchange entity;
notify the customer of the approval decision and request feedback from the customer;
receive a feedback message from the customer confirming or disputing the approval decision; and
modify the analysis based on the received feedback.

16. The method of claim 15, wherein the analysis is a machine-learning model configured to identify the exchange entity from the information.

17. The method of claim 16, wherein the feedback message indicates that the exchange was erroneously approved or erroneously denied.

18. The method of claim 17, further comprising:
in response to the feedback message, retraining the machine-learning model with new data derived from the feedback message.

19. The method of claim 18, further comprising:
tabulating a total number of erroneous approval decisions made relative to the exchange entity; and
comparing the total number to a predetermined threshold,
wherein the retraining of the machine-learning model is performed only in response to the total number exceeding the predetermined threshold.

20. The method of claim 19, further comprising:
notifying the customer to retry the exchange in response to the retraining.
